(19) United States
(12) Patent Application Publication
(10) Pub. No.: US 2026/0228352 A1
(43) Pub. Date: Aug. 6, 2026

(54) Ephemeral Virtualized Execution and Memory Confinement Platform for CPU/GPU Data Zeroization and Immutable Proof-of-Erasure

(71) Applicant: Ryan Paul Warren, Green Cove Springs, FL (US)

(72) Inventor: Ryan Paul Warren, Green Cove Springs, FL (US)

(21) Appl. No.: 19/047,096

(22) Filed: Feb. 6, 2025

(51) Int. Cl. G06F 21/62

(52) U.S. Cl. CPC G06F 21/6218

(57) ABSTRACT

A system and method for secure ephemeral data handling in multi-tenant and high-performance computing environments is disclosed. The invention enforces locked, non-swappable CPU and GPU memory allocations so data remains confined to volatile memory. Each ephemeral “micro-VM” session maintains a unique cryptographic context and concurrency controls. Upon deallocation, memory is overwritten with zeros and cryptographically verified as zeroed before reuse. Zeroization events are optionally logged on a blockchain or tamper-evident ledger, providing immutable proof-of-erasure. This unified approach targets vulnerabilities in memory swapping, incomplete sanitization, GPU buffer reuse, and regulatory audit requirements by integrating ephemeral CPU/GPU memory with cryptographic zeroization and verifiable destruction records.

### ORIGIN OF THE INVENTION

The invention originated from the named inventor (Ryan Paul Warren) in the normal course of his research and was not made under a government contract or joint research agreement.

### DESCRIPTION

For ease of understanding, the description is divided into subsections covering an overview of the invention, its architecture, zeroization mechanisms, blockchain logging, and potential applications.

### BACKGROUND OF THE INVENTION

### Prior Art References:

U.S. Pat. No. 11,726,868 B2 (System for Protecting GPU Memory Instructions) Focuses on GPU fault tolerance by converting redundant instructions into dummy operations, not on cryptographic sanitization or zero-state verification.
U.S. Pat. No. 7,623,134 B1 (GPU Paging to System Memory)-Provides virtual memory expansion but lacks ephemeral GPU isolation or zeroization.
US 2012/0093318 A1 (Encryption Key Destruction)-Relies on physical key removal or external interfaces; not directly applicable to ephemeral RAM/GPU sanitization.
U.S. Pat. No. 9,436,618 (Zero Content Over Garbage Data)-Prevents unintentional generation of garbage data but lacks a cryptographic hash check for overwritten regions.
US 2016/0283920 A1 (Blockchain for Data Authentication)-Logs file hashes on-chain but does not integrate memory zeroization.
U.S. Pat. No. 11,175,826 (NIST Data Block Matrix)-Tracks GDPR-compliant deletions in a hash-linked structure but lacks ephemeral CPU/GPU integration.
U.S. Pat. No. 8,339,404 B2 (GPU Resource Utilization)-Optimizes GPU operations but does not isolate/verify ephemeral GPU buffers.
US 2022/0108034 A1 (Automatic Erasure in Secure Networks)

Covers secure deletion of network data, not ephemeral CPU/GPU buffers.
U.S. Pat. No. 9,537,811 B2 (Ephemeral Messaging)-Focuses on transient communications rather than ephemeral memory locking and concurrency.

Incorporation by Reference: Each of the above references is hereby incorporated by reference in its entirety for all permissible purposes. [Despite these existing solutions, no single framework unifies (i) GPU memory interception, (ii) cryptographic zeroization with verification, (iii) locked CPU/GPU memory isolation, and (iv) immutable proof-of-erasure in a blockchain or tamper-evident ledger. The present invention addresses these combined needs.

### BRIEF STATEMENT OF THE INVENTION

The invention provides an Ephemeral Virtualized Execution (EVE) framework for ephemeral data handling and proof-of-erasure in multi-tenant or HPC contexts. It achieves:
1) Locked, non-swappable CPU memory.
2) GPU memory interception & zeroization.
3) Cryptographic verification of zeroed memory.
4) Micro-VM session isolation.
5) Blockchain/tamper-evident logging of erasure events.

### SUMMARY OF THE INVENTION

EVE is an end-to-end ephemeral data management solution. It leverages locked, non-swappable RAM for CPU usage, intercepts and sanitizes GPU allocations, and verifies zeroization via a post-write cryptographic hash. Erasure events can optionally be recorded on a blockchain for immutable audit trails. This system is particularly suited for cloud, HPC, and machine-learning contexts that require strong security and compliance with regulations like HIPAA or GDPR.

### OBJECT OF THE INVENTION

The principal objectives of the invention include:
1)Preventing sensitive data from ever being paged to disk.
2)Ensuring thorough and verified zeroization of CPU and GPU memory.
3)Providing transparent audit and proof-of-erasure for compliance.
4)Maintaining concurrency controls to avoid cross-session leakage in multi-tenant HPC/ML environments.

### OBJECT AND SUMMARY OF THE INVENTION

By defining ephemeral “micro-VM” sessions backed by locked RAM, hooking GPU memory calls, and integrating a cryptographic zeroization and blockchain-logging engine, the invention enables secure, temporary data usage. Once data is no longer needed, it is wiped and irretrievably destroyed—verifiable by an on-chain record.

### FIELD AND BACKGROUND OF THE INVENTION

Field: Secure, ephemeral data handling, memory zeroization, GPU concurrency, cryptographic erasure verification, blockchain-based proof-of-deletion.

Background: Growing demands for secure, short-lived data usage—particularly in machine learning or HPC environments—drive the need for ephemeral memory solutions that incorporate end-to-end auditability.

### FIELD OF THE INVENTION

The field of this invention is secure computing and data privacy within volatile (RAM/VRAM) memory, with a specific emphasis on high-throughput or multi-tenant scenarios.

### TECHNICAL FIELD

Technical areas include operating system memory management, GPU device memory handling, cryptographic data sanitization, and distributed ledger technology for audit trails.

### PRIOR ART/DESCRIPTION OF THE PRIOR ART/BACKGROUND ART

The references listed above illustrate various partial solutions in data sanitization, GPU resource management, and blockchain hashing. None combine ephemeral CPU/GPU memory usage with verifiable zeroization and blockchain-based proof.

### DESCRIPTION OF THE PRIOR ART

Conventional ephemeral messaging or HPC frameworks do not enforce pinned memory usage, verified zeroization, or log data-destruction events on a tamper-evident ledger. GPU memory interceptors that do exist focus on performance or fault tolerance rather than ephemeral security.

### DESCRIPTION OF RELATED ART

Conventional ephemeral messaging or HPC frameworks do not enforce pinned memory usage, verified zeroization, or log data-destruction events on a tamper-evident ledger. GPU memory interceptors that do exist focus on performance or fault tolerance rather than ephemeral security.

### BRIEF DESCRIPTION OF DRAWINGS/FIGURES

FIG. 1—High-Level EVE System Architecture

FIG. 2—Soft-VM and Micro-VM Session Creation Flow.

FIG. 3—Concurrency and Page-Level Locking Mechanisms.

FIG. 4—GPU Memory Interception Workflow.

FIG. 5—Cryptographic Zeroization and Verification Process.

FIG. 6—Blockchain-Based Proof-of-Erasure.

FIG. 7—Machine-Learning Framework Integration.

FIG. 8—Example Lifecycle of EVE Sessions.

### BEST MODE FOR CARRYING OUT THE INVENTION

The best mode contemplates using an OS-level memory-locking call (e.g., mlock on Linux) to guarantee no paging to disk. For GPU memory, hooking the primary allocation and deallocation APIs ensures ephemeral buffers are sanitized reliably. A robust cryptographic library (such as OpenSSL or libsodium) validates zeroization. Finally, a lightweight blockchain or distributed ledger (e.g., Hyperledger Fabric, Ethereum) can store Merkle-rooted proofs of erasure.

### DETAILED DESCRIPTION

### 1. Introduction

The Ephemeral Virtualized Execution (EVE) platform is a next-generation system for securely handling transient or short-lived data. In modern computing environments—particularly those involving multi-tenant cloud services, high-performance computing (HPC) workloads, and machine learning frameworks—sensitive data is frequently loaded into random- access memory (RAM). Traditional memory use can expose data to numerous vulnerabilities, including accidental writes to swap/paging files, incomplete zeroization at session termination, or inadvertent cross-session memory leaks.

Eve Addresses These Vulnerabilities by Providing:
Locked, non-swappable memory regions to keep ephemeral data purely in RAM.
Fine-grained concurrency controls for safe multi-threaded or multi-process usage.
Cryptographic zeroization to overwrite memory upon release and verify that data is irretrievably destroyed.
Session-based ephemeral “micro-VMs” that encapsulate data usage for distinct sessions.
Optional GPU memory interception to extend ephemeral guarantees to GPU device memory.
Immutable proof-of-erasure via a blockchain or tamper-evident ledger, establishing public or decentralized verification that ephemeral data is indeed zeroized.

These capabilities form an ephemeral execution pipeline that ensures sensitive data, including cryptographic keys, user data, or proprietary model parameters, never persist beyond an intended lifetime.

### 2. High-Level Motivation

### 2.1 Traditional Shortcomings

Memory Swapping: Typical operating systems swap memory pages to disk under memory pressure. If those pages contain sensitive data, it may remain on disk unencrypted.
Inadequate Zeroization: Many processes or containers “free” memory without actually overwriting it. Residual data can remain in RAM or GPU buffers, accessible to adversaries or subsequent processes.
GPU Memory Complexity: HPC and machine learning tasks rely heavily on GPU acceleration. However, GPU memory allocators often recycle memory buffers without thorough zeroization, leaving stale data at risk of exposure.
Partial or No Audit Trails: Even if ephemeral memory is used, current systems do not produce cryptographic evidence or proof of data destruction that can be verified by a third party.

### 2.2 Novel Aims of EVE

Absolute In-RAM Execution: By forcing memory to be mlock-ed or otherwise pinned, ephemeral data cannot be paged out.
Granular Locking and Micro-VM Sessions: Each ephemeral “micro-VM” is segregated at the memory allocation level, with concurrency locks that prevent accidental cross-session reads/writes.
GPU Interceptor: A specialized interceptor hooks GPU memory calls (e.g., cudaMalloc, cudaFree) to maintain ephemeral GPU data under the same ephemeral and cryptographic constraints.
Blockchain-Proof: When ephemeral data is finally zeroized, EVE logs a cryptographic “erasure proof” on a distributed ledger, ensuring the destruction event is tamper-evident and publicly auditable.

### 3. Core Architecture

### 3.1 Global Manager and Configurations

At the top level, the system includes a Global Manager that holds:
Configuration: Flags for enabling GPU support, setting cryptographic strength, and limiting maximum memory usage.
Memory Manager: Responsible for locking memory pages, tracking ephemeral allocations, and controlling concurrency.
Session Manager: Maintains ephemeral “micro-VMs” or ephemeral sessions. Each session has a unique cryptographic context and concurrency rules.
Crypto Context: Stores a master key for ephemeral data encryption or hashing, includes logic for key rotation, and ensures no stale keys remain accessible across sessions.

This global manager ensures consistent policies (e.g., maximum concurrency, memory usage) are enforced system-wide.

### 3.2 Soft-VM and Micro-VM Concept

The invention leverages a Soft-VM layer, which is effectively a software-based virtualization of memory. This layer:
Allocates a large contiguous block of system memory using operating system calls like mmap (on Linux) or VirtualAlloc (on Windows).
Locks the memory region, ensuring it will not be swapped to disk.
Manages page-level metadata (e.g., allocation time, cryptographic nonce, hash values).
Provides an interface for creating ephemeral Micro-VMs, each representing an isolated session within the overarching ephemeral environment.

Each Micro-VM is assigned:
A session ID, typically a UUID.
A crypto sub-context with a session-specific key or nonce.
A page tracking mechanism referencing the pages owned by that session.
Lifecycle states: INITIALIZING, ACTIVE, TEARDOWN_PENDING, DESTROYED.

By separating ephemeral data usage into distinct Micro-VM descriptors, different workloads or tenants can run concurrently without risking memory collisions or unauthorized cross-access.

### 3.3 Ephemeral Environment

Ephemeral Environment: As used herein, the term “ephemeral environment” encompasses ephemeral sessions, ephemeral containers, ephemeral micro-VMs, soft-VMs, or any analogous transient execution abstraction.

### 4. Memory Isolation and Concurrency

### 4.1 Page-Level Locking

To avoid race conditions in ephemeral memory management, the system uses:
Global Mutex or RWLock: For high-level memory region operations (initializing locked memory, resizing, etc.).
Per-Page Mutexes: Each ephemeral page in the system has a dedicated or array-indexed mutex to coordinate concurrent reads/writes by multiple threads.
Session Locks: The session manager uses read/write locks to allow multiple concurrent read operations on session metadata, but exclusive write locking when the session's ephemeral memory is reconfigured or destroyed.

This multi-tier concurrency design is unusual compared to typical container or VM solutions. It minimizes overhead by restricting the scope of locks and ensures ephemeral data remains protected even in multi-threaded HPC or ML contexts.

### 4.2 GPU Interception

A distinctive aspect is the GPU memory interceptor. Modern GPU runtimes often re-use device memory pools without guaranteed zeroization. By hooking or overriding standard GPU memory functions, the invention:
Allocates GPU memory specifically designated as ephemeral (bypassing default GPU memory pools, if needed).
Tracks ephemeral GPU pages or buffers in a concurrency-safe manner, akin to CPU ephemeral pages.
Performs cryptographic zeroization upon deallocation, verifying the GPU buffer has been overwritten (via GPU kernels or cudaMemsetAsync).
Maintains session boundaries: Only the micro-VM session owning a GPU buffer can read or modify it.

This extension to GPU memory ensures ephemeral data used by HPC or machine-learning tasks is held to the same ephemeral standard as CPU memory.

### 5. Cryptographic Zeroization & Verification

### 5.1 Zeroization Rationale

When ephemeral data is no longer needed (e.g., upon session teardown or block release), it must be reliably wiped from memory. Simply freeing pages may leave remnants of data accessible to future allocations.

### 5.2 the Zeroization Process

Mark the Page: The page transitions to a “PENDING_ZERO” state, preventing new allocations from reusing it prematurely.
Overwrite: the Entire Page or Buffer Is Overwritten With Zero Values.
Hash & Compare: A post-write hash of the page contents is computed and compared with a reference “verification token” or a known hash for all-zero data. If any mismatch arises, the system logs a security anomaly.
State Update: The page state is updated to “VERIFIED_ZERO,” indicating that memory is now considered sanitized and can be reallocated safely to other ephemeral or non-ephemeral tasks.

### 5.3 GPU Zeroization

For GPU memory, the same concept applies:
A specialized zeroization kernel or cudaMemset call overwrites the entire buffer with zeros.
A verification step may run a GPU-based or partially CPU-based hashing routine to confirm the buffer is indeed zero.
Key Distinction: Because GPU data can remain in VRAM, it is essential to ensure ephemeral pages are not left in untracked device memory segments.

### 6. Blockchain-Based Proof-of-Erasure

### 6.1 Motivation for Immutable Audit Trails

While ephemeral execution ensures data is destroyed in memory, an external or third-party entity may require cryptographic proof that the destruction truly occurred. Traditional logs can be modified or lost. By leveraging a blockchain:
Erasure events (each referencing a block ID, page ID, or ephemeral session ID) can be hashed and published in a tamper-evident manner.
A Merkle tree can be constructed for multiple zeroization events, with its root committed on-chain to reduce transaction costs.

### 6.2 Example Workflow

Generate an Erasure Record: Once a page is verified zeroized, a cryptographic record is produced, e.g., Hash(blockID ||finalStateHash|| timestamp).
Sign or Submit: This record is signed with the ephemeral session's key or a system key and submitted to a smart contract.
Blockchain Logging: The contract logs the event. If subsequent auditing is required, the on-chain event proves the data was claimed to be erased at a given time.
Certificate Aggregation: Multiple ephemeral blocks from a single session can be combined into a “wipe certificate,” referencing a Merkle root. This efficiently conveys that all ephemeral data from a session is zeroized without spamming the blockchain with each event individually.

This approach fosters public auditability, beneficial for compliance (e.g., GDPR “right to be forgotten” scenarios) or inter-organizational trust.

### 7. Integration with Machine Learning Frameworks

### 7.1 Activation Overlays

Many transformer-based or neural network frameworks store large activation tensors in GPU memory. By default, such memory might remain allocated or reallocated to subsequent models. EVE introduces a concept of activation overlays:
Ephemeral data (like attention caches or intermediate hidden states) is injected into the model's forward/backward pass.
Once the pass is complete, ephemeral memory is strictly zeroized.
The ephemeral allocations are tracked so they cannot be inadvertently re-used with stale data intact.

### 7.2 Post-layer Cleanup

After each layer or subgraph, the ephemeral memory allocated specifically for that operation is forcibly overwritten, ensuring no lingering intermediate data remains accessible. This fosters compliance and security, particularly in multi-user ML inference or HPC clusters.

### 8. Why This Invention is Novel

### 8.1 Combined and Unified Features

Many systems exist for memory locking, ephemeral usage, or blockchain logging. However, EVE combines these features in a unique arrangement:
Comprehensive CPU and GPU Hooking Under a Single Ephemeral manager.
Cryptographic zeroization verified by comparing a post-write hash to a reference.
Session-based concurrency with micro-VM descriptors, ensuring ephemeral data is never accessible across session boundaries, even in multi-tenant or HPC contexts.
Blockchain-based proof-of-erasure integrated from the ground up, giving an immutable record of ephemeral data destruction.
End-to-end ephemeral pipeline that spans from memory lock acquisition through final zeroization, bridging CPU and GPU resources in the same ephemeral paradigm.

### 8.2 Distinction From Enclave-Like Solutions

Hardware enclaves (e.g., Intel SGX) protect memory in a specialized environment. By contrast, EVE:
Operates at the software and OS level for universal compatibility, not relying solely on vendor enclaves.
Intercepts GPU memory—something enclaves typically do not handle seamlessly.
Emphasizes cryptographic logging and externally verifiable zeroization, which is typically not included in standard enclave usage.

### 8.3 Fine-Grained Concurrency for Multi-Tenant HPC

While some container or VM technologies claim ephemeral usage, they often do not provide:
Per-page concurrency locks and read-write session locks.
Integration with HPC or ML frameworks that reuse memory buffers intensively.
Proof of ephemeral data destruction beyond ephemeral container lifetimes.

### 8.4 Cryptographic Zero-state Verification

Standard solutions might overwrite memory, but do not confirm correctness of the overwrite. In EVE, hashing the post-overwrite content ensures guaranteed zeroization rather than a best-effort approach.

### 9. Potential Use Cases

Finance/Banking: Temporary computations on sensitive financial data can run in ephemeral memory. After use, all data is cryptographically zeroized, and a blockchain record proves compliance.
Healthcare Analytics: Data scientists analyzing patient records do so within ephemeral GPU memory for advanced ML. Post-analysis, the ephemeral session is destroyed, ensuring no personal health information remains.
Edge Computing: On edge devices with limited disk encryption, ephemeral memory ensures data never leaves volatile RAM, mitigating physical device capture risks.
Multi-User ML Inference: A shared HPC cluster runs ephemeral micro-VM sessions. Model inferences or partial training steps are guaranteed ephemeral, so user A's data cannot leak into user B's environment.
Tamper-Evident Auditing: Organizations or clients can verify data destruction events on a blockchain, satisfying regulatory demands or contractual obligations for data privacy.

### 10. Lifecycle of the System

Initialization: The system locks a large region of memory or uses OS-level calls to ensure no swapping. It sets up concurrency locks, hashtables for tracking pages, and loads cryptographic keys.
Session Creation: A new ephemeral micro-VM (session) is instantiated, assigned a session key/nonce, and granted a portion of ephemeral memory.
Data Usage: The user or application loads sensitive data (CPU or GPU), possibly hooking into HPC or ML pipelines. Concurrency structures ensure no cross-access from other sessions.
Zeroization: Once data is no longer needed (or session ends), the ephemeral pages are overwritten with zeros and hashed. Failing a verification triggers an alarm or logs an anomaly.
Blockchain Logging: If configured, each zeroization event or batched set of events is recorded on-chain, providing immutable proof-of-erasure.
Cleanup: The ephemeral pages are reflagged as FREE or reallocated for subsequent ephemeral usage, ensuring no stale data persists.

### 11. Conclusion

The Ephemeral Virtualized Execution (EVE) invention delivers a holistic approach to ephemeral memory management, spanning CPU and GPU realms, guided by concurrency locks, cryptographic zeroization, and verifiable proof-of-destruction. Its novelty lies in the unified design that merges:
Locked ephemeral memory with concurrency;
GPU hooking to handle HPC/ML use cases;
Post-overwrite hash verification to guarantee sanitization;
Blockchain or tamper-evident ledger integration for auditable proof-of-erasure.

This system addresses critical gaps in data privacy, compliance, and memory isolation, paving the way for secure ephemeral data handling in both cloud and edge computing contexts.

### DETAILED DESCRIPTION OF THE DRAWINGS

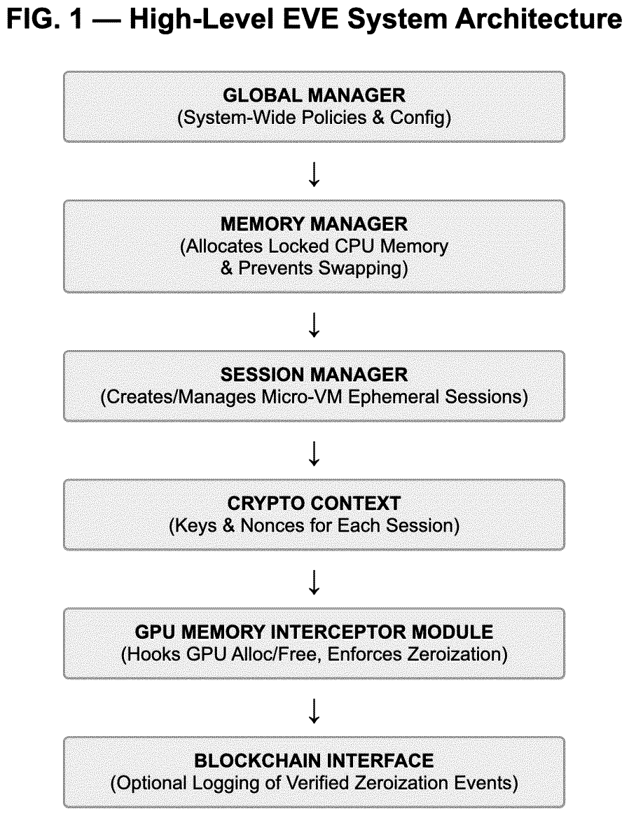

### FIG. 1—High-Level Eve System Architecture

This figure illustrates the overall structure of the Ephemeral Virtualized Execution (EVE) platform and the interactions among its primary components:
1. Global Manager: Applies and enforces system-wide security, cryptographic, and concurrency policies. It also maintains global configuration parameters for ephemeral memory handling.
2. Memory Manager: Allocates a locked, contiguous region of system RAM that cannot be swapped out to disk. This manager ensures that all ephemeral data remains strictly in volatile memory, preventing persistent storage of sensitive information.
3. Session Manager: Handles the creation, configuration, and teardown of ephemeral “micro-VM” sessions. Each session includes metadata (such as a Session ID, lifecycle state, and assigned memory pages). The Session Manager also coordinates concurrency locks at the session level.
4. Crypto Context: Stores or generates cryptographic materials (e.g., session keys, nonces) used for zeroization verification and secure data isolation. This context ensures each ephemeral session is cryptographically distinct, mitigating cross-session data leaks.

Communication flows among these components are shown by arrows, indicating how the Global Manager orchestrates policy, the Memory Manager secures physical RAM, the Session Manager spawns or terminates ephemeral sessions, and the Crypto Context provides cryptographic support.

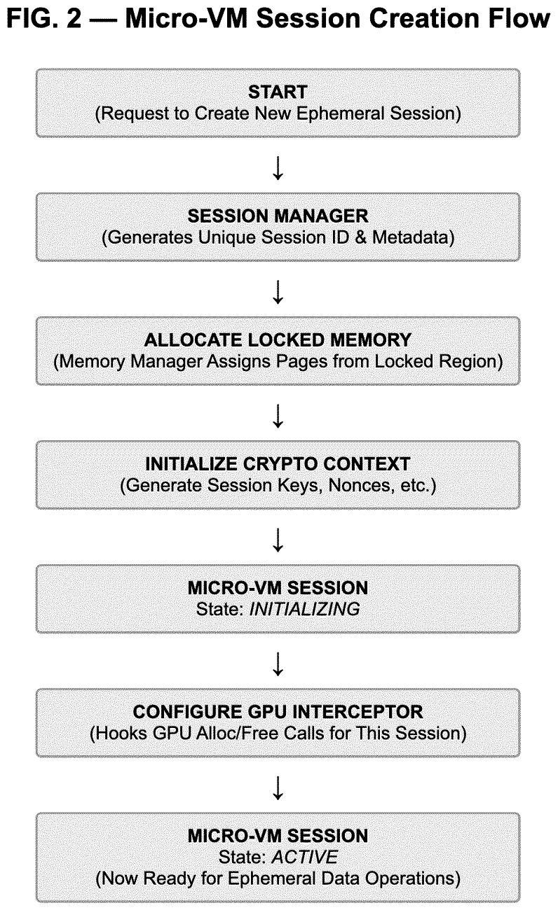

### FIG. 2—Micro-VM Session Creation Flow

This figure provides a step-by-step view of how a new ephemeral “micro-VM” session is formed:
1. Session Request: The process begins with a request to create a new ephemeral session.
2. Session ID & Metadata: The Session Manager generates a unique Session ID (e.g., a UUID) and associates relevant metadata (e.g., user context, purpose).
3. Locked RAM Allocation: The Memory Manager allocates pages from its locked region, ensuring that this memory will not be swapped to disk.
4. Crypto Context Initialization: A session-specific cryptographic context is established, which may involve generating random keys, nonces, or other secure parameters.
5. Session State (INITIALIZING→ACTIVE): Once setup is complete, the session transitions to ACTIVE, allowing ephemeral read/write operations in CPU and GPU memory.
6. GPU Interceptor Setup: If applicable, hooks for GPU allocation/deallocation calls (e.g., cudaMalloc, cudaFree) are configured under this session. The figure depicts how these steps occur in sequence, ensuring ephemeral memory isolation and cryptographic preparation before the session becomes fully operational.

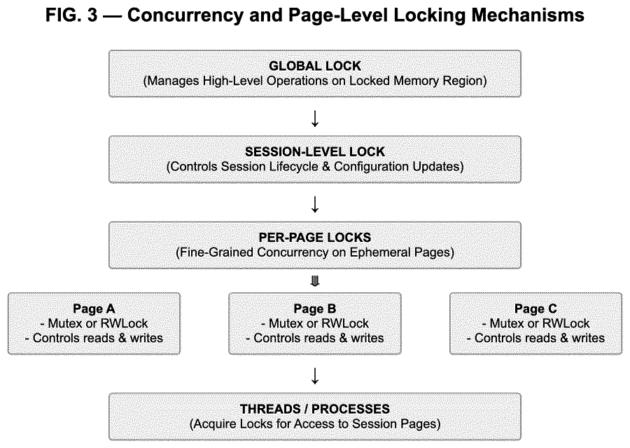

### FIG. 3—Concurrency and Page-level Locking Mechanisms

This figure shows the hierarchical locking scheme that prevents data races and enforces memory isolation across multiple threads and sessions:
1. Global Lock: At the highest level, a global lock (often a read-write lock) governs significant operations affecting the entire locked memory region (e.g., resizing the region, major reconfigurations).
2. Session-Level Lock: Each micro-VM session is assigned a lock, controlling state transitions (e.g., from ACTIVE to TEARDOWN_PENDING). This ensures that changes to a session (like destruction or resizing of memory) do not interfere with other concurrent sessions.
3. Per-Page Locks: The most granular level of locking is at the individual memory page. Each page can have a mutex or read-write lock to coordinate reads and writes among multiple threads. This allows fine-grained concurrency in high-performance computing or machine-learning workloads while preventing cross-session data contamination.
4. Example Pages (A, B, C): The figure illustrates multiple pages, each with its own lock. Threads and processes acquire these locks to safely access ephemeral data. By layering global, session-level, and page-level locks, the system achieves efficient, secure concurrency.

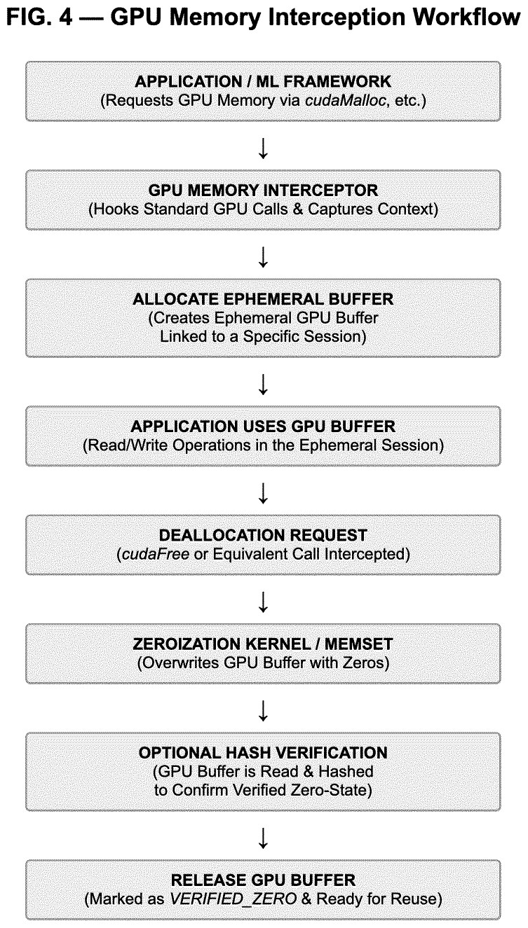

### FIG. 4—GPU Memory Interception Workflow

This figure outlines how the EVE platform intercepts GPU memory function calls and enforces ephemeral usage:
1. Application/Framework Request: A high-level API call such as cudaMalloc originates from a user application or ML framework.
2. GPU Memory Interceptor: Instead of directly calling the native GPU API, the request is routed through an interceptor module that keeps track of ephemeral allocations, linking them to a specific micro-VM session.
3. Ephemeral Buffer Allocation: The interceptor allocates a GPU buffer in ephemeral mode, recording metadata (e.g., buffer ID, session ID).
4. Buffer Usage: The application can now use this ephemeral buffer for GPU-accelerated computations, such as neural network training or HPC tasks.
5. Deallocation Request: When the application calls cudaFree or an equivalent function, the interceptor intercepts this call again.
6. Zeroization: A GPU kernel or cudaMemset operation overwrites the buffer with zeros.
7. Optional Hash Verification: The system may compute a cryptographic hash of the newly zeroed buffer to confirm a “verified zero” state.
8. Release: The buffer is finally released for reuse. This interception process ensures ephemeral data in GPU memory is promptly destroyed.

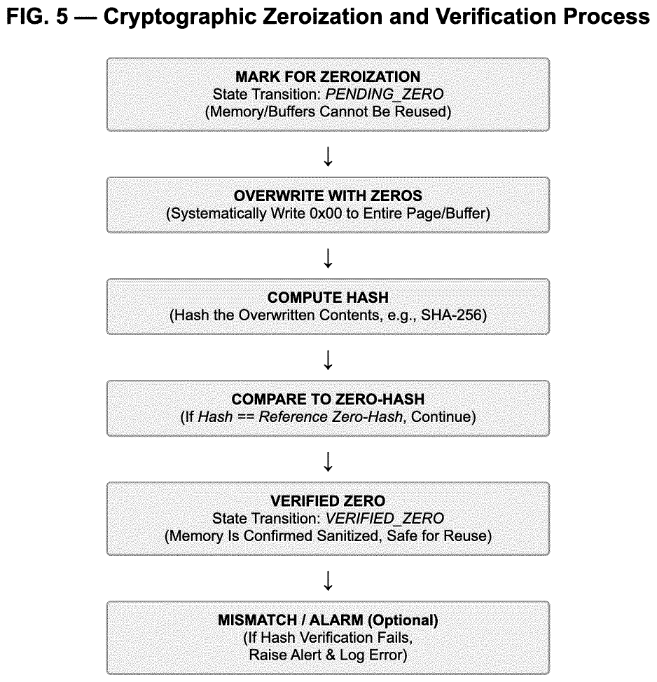

### FIG. 5—Cryptographic Zeroization and Verification Process

This figure details the system's mechanism for securely wiping and verifying that data has been erased:
1. Mark for Zeroization: When a page or buffer is no longer needed, it transitions to a PENDING_ZERO state, indicating it must not be reused or accessed for normal data.
2. Overwrite with Zeros: The system writes zero bytes (0x00) across the entire memory region.
3. Compute Hash: A cryptographic hash (e.g., SHA-256) is calculated over the overwritten contents.
4. Compare to Zero-Hash: The computed hash is compared against a reference “all-zero” hash for the same size.
5. Verified Zero: If the hash matches, the memory is deemed sanitized (VERIFIED_ZERO), ensuring no remnants of the original data remain.
6. Mismatch/Alarm: In the rare case the hash differs, an alert is raised or logged, possibly indicating hardware or software anomalies.

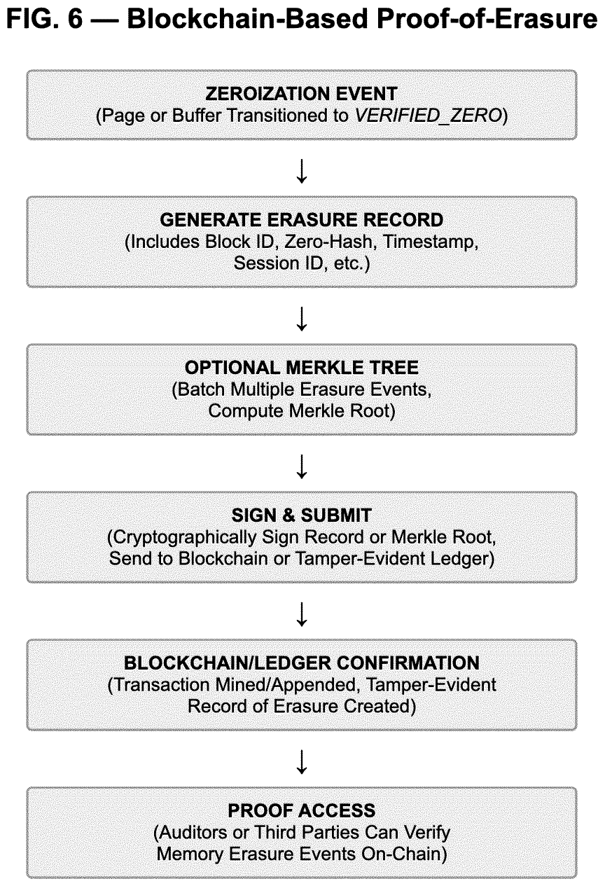

### FIG. 6—Blockchain-Based Proof-of-Erasure

This figure shows how verified zeroization events can be immutably recorded:
1. Zeroization Event: Once a page or buffer is confirmed zeroed (i.e., VERIFIED_ZERO), the system creates an erasure record containing key data (block ID, final zero-hash, timestamp, etc.).
2. Merkle Tree (Optional): Multiple erasure records can be combined into a Merkle tree to efficiently batch them, reducing on-chain transaction costs.
3. Sign & Submit: The root hash or individual record is digitally signed using a private key and sent to a blockchain or tamper-evident ledger.
4. On-Chain Confirmation: The network (e.g., miners or validators) appends the transaction, forming an immutable record.
5. Proof Access: Auditors, regulators, or clients can later verify the zeroization event on-chain, confirming that sensitive data was destroyed at a specific time.

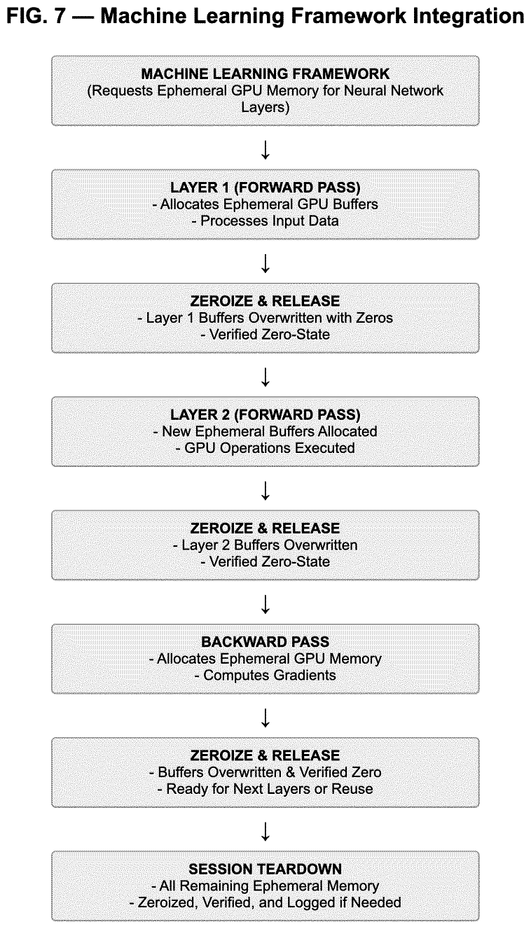

### FIG. 7—Machine-Learning Framework Integration

This figure offers a practical example of how ephemeral memory can be employed in a layered neural network workflow:
1. ML Framework: A higher-level library (e.g., Tensorflow, Pytorch) requests GPU memory for neural network layers.
2. Layer 1, Forward Pass: Ephemeral buffers are allocated for input activations, then used for computation.
3. Zeroize & Release: Once the layer completes, those buffers are overwritten with zeros and verified, preventing any stale data from persisting.
4. Subsequent Layers: Each layer (or subsequent pass) follows the same allocate-use-zeroize cycle, ensuring ephemeral buffers do not leak between stages.
5. Backward Pass: During training, gradients are similarly placed in ephemeral buffers and zeroized once they are no longer needed.
6. Session Teardown: The figure concludes with session termination, where all ephemeral GPU memory is wiped and cryptographically confirmed.

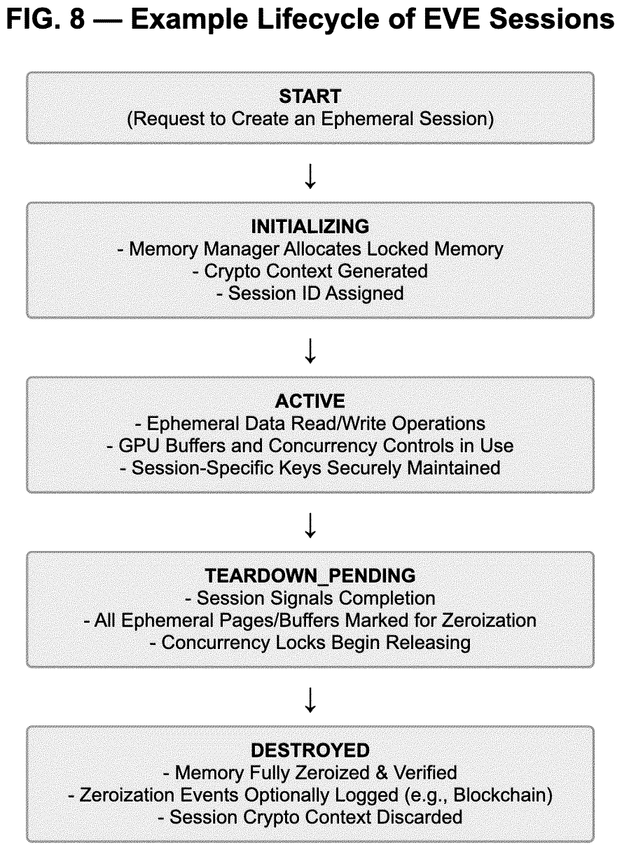

### FIG. 8—Example Lifecycle of Eve Sessions

This figure summarizes the states each ephemeral session undergoes:
1. Start: A request is made to create a new ephemeral session.
2. Initializing: The Memory Manager locks pages for the session; the Crypto Context is set up, and concurrency data structures are prepared.
3. Active: The session allows reading and writing of ephemeral memory and GPU buffers. Concurrency controls are in place to protect data from cross-session leaks.
4. Teardown Pending: The session signals its end-of-life; all allocated pages and buffers transition to PENDING_ZERO, awaiting zeroization.
5. Destroyed: Once all memory is overwritten and verified (VERIFIED_ZERO), the session is fully terminated. Any zeroization events may be optionally logged to a blockchain. The cryptographic context is discarded, ensuring no stale keys remain.

1. A system for secure ephemeral data handling, comprising:
a. a memory manager configured to allocate one or more regions of system memory designated as ephemeral, each region pinned or locked to prevent swapping to disk or storing to non-volatile memory;
b. a session manager configured to create one or more ephemeral environments, each ephemeral environment selected from the group consisting of ephemeral sessions, ephemeral containers, ephemeral micro-VMs, soft-VMs, or any equivalent transient execution context, each environment comprising a unique cryptographic context and a set of memory pages within the ephemeral region;
c. a concurrency control mechanism comprising:
i. at least one global lock for managing high-level operations on the ephemeral region; and
ii. per-page locks for coordinating multi-threaded read and write operations on each memory page;
d. a zeroization engine configured to overwrite data in each memory page with an irretrievable pattern, such as zero values, upon release, compute a cryptographic hash of the overwritten content, and verify the page is in a zeroed or otherwise sanitized state; and
e. a blockchain interface configured to generate an erasure record for each zeroization event and commit or transmit said record to a blockchain or other tamper-evident ledger.

2. The system of claim 1, wherein the session manager further enforces a lifecycle for each ephemeral environment, including at least an INITIALIZING state, an ACTIVE state, a TEARDOWN_PENDING state, and a DESTROYED state.

3. The system of claim 1, wherein the cryptographic hash is compared against a reference hash corresponding to the expected overwritten data to confirm successful zeroization.

4. The system of claim 1, further comprising one or more GPU and/or accelerator memory interceptor modules configured to:
a. override standard device memory allocation and deallocation calls; and
b. maintain a concurrency-safe ledger of allocated device buffers linked to the corresponding ephemeral environment.

5. The system of claim 4, wherein the GPU or accelerator memory interceptor module is configured to invoke a kernel or specialized memory set operation to overwrite device buffers with an irretrievable pattern upon deallocation.

6. The system of claim 4, wherein the zeroization engine further verifies the zeroed state of device buffers by performing a hash-and-compare operation on the device buffer contents.

7. The system of claim 1, wherein the blockchain interface generates a Merkle tree of multiple zeroization events, computes a Merkle root, and posts the Merkle root to the blockchain to reduce transaction overhead.

8. A method of enforcing ephemeral data usage, comprising:
a. allocating at least one region of system memory and designating said region to prevent swapping or persistent storage. If an OS forcibly pages data it must be encrypted;
b. creating an ephemeral environment having a unique cryptographic context and a set of memory pages within the ephemeral region;
c. intercepting device memory operations to allocate ephemeral GPU or accelerator buffers under said ephemeral environment;
d. receiving a request to deallocate at least one page or device buffer belonging to the ephemeral environment;
e. marking said page or buffer as pending zeroization and overwriting its contents with an irretrievable pattern;
f. computing a cryptographic hash of the overwritten contents and comparing it to a reference hash; and
g. recording a verified zeroization event in an immutable ledger.

9. The method of claim 8, wherein the step of creating an ephemeral environment includes assigning a unique environment identifier and initializing environment-specific cryptographic keys that are inaccessible to other environments.

10. The method of claim 8, wherein intercepting device memory operations comprises hooking calls to at least one API selected from a group consisting of cudaMalloc, cudaFree, OpenCL memory calls, specialized accelerator memory routines, and equivalent GPU or accelerator memory management functions.

11. The method of claim 8, wherein recording a verified zeroization event in an immutable ledger comprises cryptographically signing the event record and submitting it to a blockchain smart contract.

12. A non-transitory computer-readable medium storing instructions that, when executed by a processor, cause the system to perform the method of claim 8.

13. A secure ephemeral environment, comprising:
a. a plurality of ephemeral execution contexts, each context having a unique identifier and isolated memory pages pinned in RAM or accelerator memory;
b. concurrency locks at global, context, and per-page granularity to facilitate multi-threaded data access while preventing cross-environment data leakage;
c. cryptographic zeroization routines enforced at the page or buffer level, wherein each page or buffer is overwritten with an irretrievable pattern and verified before being reallocated; and
d. a blockchain-based erasure logging mechanism that publishes zeroization proof records for each ephemeral execution context upon teardown.

14. The environment of claim 13, wherein each ephemeral execution context includes a GPU or accelerator sub-context that tracks device buffer allocations in a manner analogous to CPU pages.

15. The environment of claim 13, wherein the concurrency locks include a global read-write lock for system-level memory reconfiguration, environment-level locks for ephemeral environment changes, and per-page locks for fine-grained data access control.
